(19) United States
(12) Patent Application Publication
(10) Pub. No.: US 2023/0185645 A1
(43) Pub. Date: Jun. 15, 2023

(54) INTELLIGENT API CONSUMPTION

(71) Applicant: Citrix Systems, Inc., Fort Lauderdale, FL (US)

(72) Inventor: Subramanian Krishnan, Bangalore (IN)

(21) Appl. No.: 17/547,591

(22) Filed: Dec. 10, 2021

(51) Int. Cl. G06F 9/54

(52) U.S. Cl. CPC G06F 9/547; H04L 63/0272

(57) ABSTRACT

In one disclose method, an API call from an application may be received at a first application programming interface (API) endpoint of a first computing system positioned before an egress point of a private network in which the application is executing. The first computing system may send the API call over the internet to a second API endpoint, and at least a first action may be initiated based at least in part on a response to the API call being indicative of a deficiency in execution of the API call by the second API endpoint.

### BACKGROUND

Various systems have been developed that allow client devices to access applications and/or data files over a network. Certain products offered by Citrix Systems, Inc., of Fort Lauderdale, FL, including the Citrix Workspace™ and Citrix ShareFile® families of products, provide such capabilities. Some such systems employ applications or services that can be accessed over the internet via Web application programming interface (Web API) calls from client devices or systems, and/or that can themselves access remote applications or services via Web API calls.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves receiving, at a first application programming interface (API) endpoint of a first computing system positioned before an egress point of a private network in which an application is executing, an API call from the application; sending, by the first computing system, the API call over the internet to a second API endpoint; and initiating at least a first action based at least in part on a response to the API call being indicative of a deficiency in execution of the API call by the second API endpoint.

In some disclosed embodiments, a method involves receiving, at a first application programming interface (API) endpoint of a first computing system positioned before an egress point of a private network in which an application is executing, API calls from the application; sending, by the first computing system, the API calls over the internet to a second API endpoint; and causing at least one notification to be sent to at least a first individual based at least in part on a first operational characteristic of the first API endpoint meeting a first criterion.

In some disclosed embodiments, a system comprises at least one processor, and at least one computer-readable medium encoded with instructions which, when executed by the at least one processor, cause the system to receive, at a first application programming interface (API) endpoint of a first computing system positioned before an egress point of a private network in which an application is executing, an API call from the application, to send, by the first computing system, the API call over the internet to a second API endpoint, to receive, by the first computing system and from the second API endpoint, a response to the API call, and to initiate at least a first action based at least in part on a response to the API call being indicative of a deficiency in execution of the API call by the second API endpoint.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example system in which an API gateway is configured to operate as a forward proxy server for one or more applications in accordance with some aspects of the present disclosure;

FIG. 1B is block diagram illustrating additional details of the system shown in FIG. 1A;

FIG. 1C shows an example data set that may define API consumption configuration data for the API consumption monitoring service shown in FIG. 1B;

FIG. 2 is a diagram of a network environment in which some embodiments of the systems disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5 shows a first sequence diagram illustrating example actions that may be taken by and amongst various components shown in FIG. 1B to deploy a proxy configuration on an API gateway for use by an application;

FIG. 6 shows a second sequence diagram illustrating example actions that may be taken by and amongst various components shown in FIG. 1B when an application makes an API calls to an API gateway on which a proxy configuration has been deployed;

FIG. 7 shows a first example routine that may be performed by the API consumption monitoring service 132 shown in FIG. 1B;

FIG. 8 shows a second example routine that may be performed by the API gateway shown in FIG. 1B; and

FIG. 9 shows a third example routine that may be performed by the API gateway shown in FIG. 1B, or another computing system in communication with that API gateway.

### DETAILED DESCRIPTION

For purposes of reading the description of the various embodiments below, the following descriptions of the sections of the specification and their respective contents may be helpful:

Section A provides an introduction to example embodiments of a system for enabling the intelligent consumption of APIs, configured in accordance with some aspects of the present disclosure;

Section B describes a network environment which may be useful for practicing embodiments described herein;

Section C describes a computing system which may be useful for practicing embodiments described herein;

Section D describes embodiments of systems and methods for accessing computing resources using a cloud computing environment;

Section E provides a more detailed description of example embodiments of the system for enabling the intelligent consumption of APIs introduced in Section A; and

Section F describes example implementations of methods, systems/devices, and computer-readable media in accordance with the present disclosure.

### A. Introduction to Illustrative Embodiments of a System for Enabling the Intelligent Consumption of APIs

Web APIs are ubiquitous. It is common for a given application to integrate with a large number (perhaps dozens or more) of Web APIs of 3^{rd} party API services (referred to herein as “3^{rd} party APIs”), which are typically managed by entities that are unaffiliated with the application owner/platform team. Such 3rd party APIs may, for example, provide access to some data or functionality required by the application for its business processing. Likewise, such 3rd party APIs entail their costs, processing times, and even failures, which can have a profound impact on the application under consideration.

For example, a failure of a 3rd party API may result in the failure cascading all the way up to the core of the business processing of the application. While the 3rd party API call failure may be the trigger for the failure of the core business processing, the fact that the 3rd party API caused the failure might not be always evident at first glance. It may instead appear that the core business processing has itself failed, and the true source of the failure may be discovered only after a deeper investigation is performed. Such an investigation may take days of effort and require significant manual effort. By the same logic, it may so happen that a 3rd party API has excessively long response times, which results in the responsiveness of an application being impacted. Or the quantity and/or rate of API calls made to a 3rd party API has unexpectedly exceeded an anticipated quantity and/or rate (or related consumption threshold for the same).

In all these cases, although it is possible to investigate and determine the root cause of the problem to be the 3rd party APIs, to establish cause and effect can require significant time, effort and manual intervention. It is not something that happens automatically and outright. Further, following up with the entity providing the 3rd party API service typically begins only after an internal investigation has been completed by the application owner/platform team and an incident has been opened (likely manually), thus leading to a waste of precious time and incurring a business impact.

The inventor has thus recognized and appreciated a need to address these problems by being proactive and automatically doing detection and/or response as close to the problem origination point as possible. To meet that need, a system is offered in which an API gateway, i.e., a component that is generally employed by providers of 3rd party API services to manage incoming Web API calls from client applications, is re-purposed to serve the needs of an application owner/platform team, by intelligently monitoring the consumption of 3rd party APIs by the application.

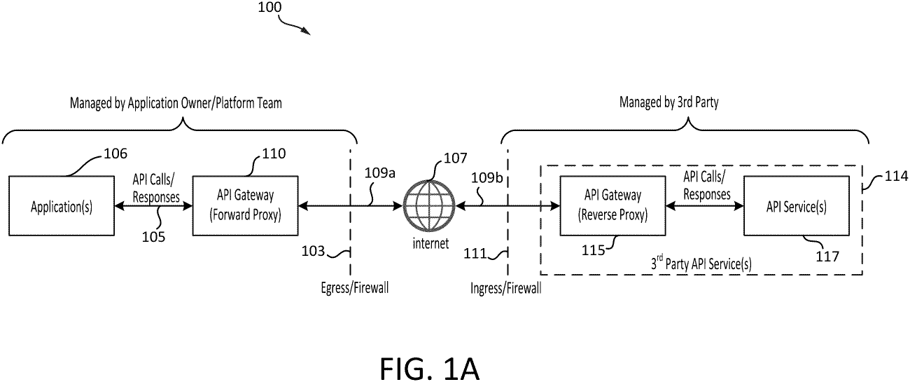

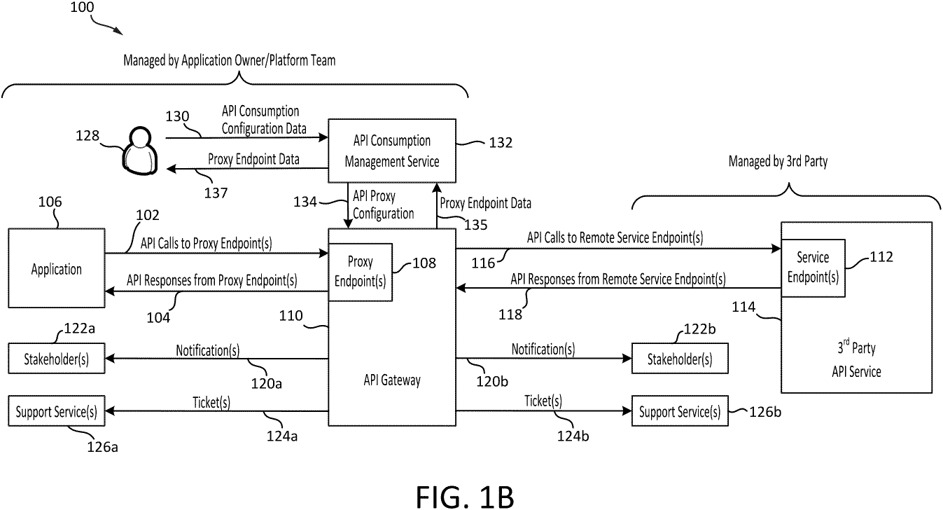

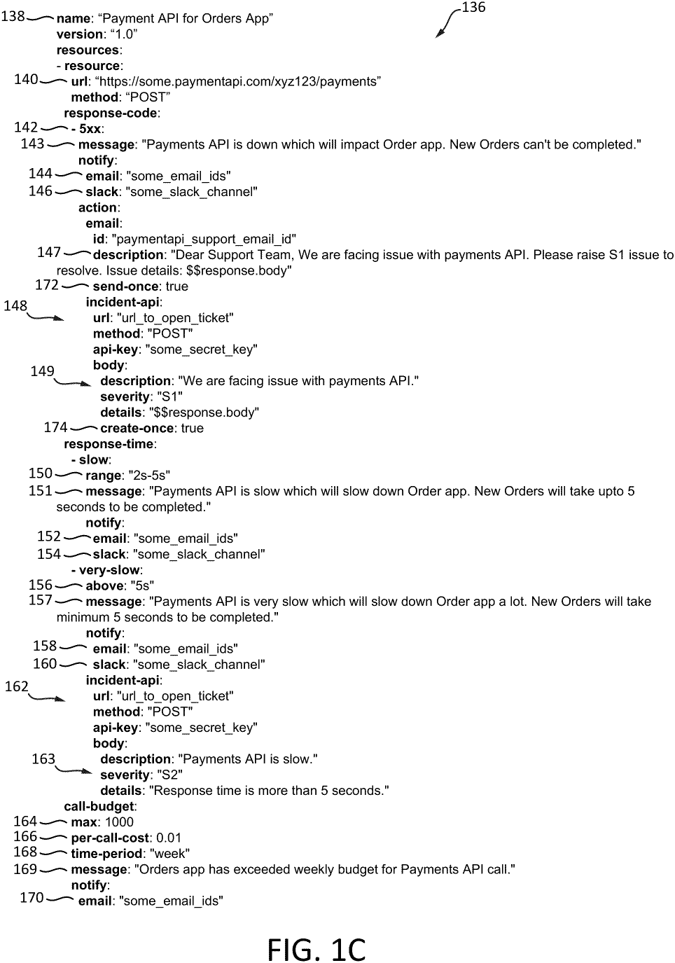

API gateways generally operate as reverse proxy servers (such as the API gateway 115 shown in FIG. 1A - described below) that direct incoming Web API calls (i.e., API calls received over the internet) to appropriate backend servers. In some circumstances, such reverse proxy servers may be situated behind the firewalls of private networks. Such a reverse proxy servers may provide an additional level of abstraction and control to ensure the smooth flow of network traffic between clients and servers. The API gateways in such circumstances are generally configured and operated exclusively under the control of the entities providing the 3rd party API services. To client applications that consume such 3rd party API services, such API gateways operate only as API endpoints and any other benefits or services offered by such gateways are not visible or accessible to the client applications or others unaffiliated with the service provider.

In some implementations of the novel systems disclosed herein, an API gateway may instead be operated as a forward proxy server for an application, such that it receives API calls from the application and passes those API calls over the internet to a 3rd party API service. As such, the API gateway may be configured and operated in accordance with the directives of application developers or others affiliated with the application owner and/or platform team. FIG. 1A shows an example of a system 100 in which an API gateway 110 is configured to operate as a forward proxy server in such a manner. As shown in FIG. 1A, in some implementations, the API gateway 110 may be positioned before a firewall or other egress point 103 of a private network (e.g., a physical network or a virtual private network (VPN)) in which one or more applications 106 are executing. As indicated, the application(s) 106 and the API gateway 110 may both be managed by the owner / platform team of the application(s) 106. As indicated by an arrow 105 in FIG. 1A, rather than sending API calls directly to a 3^{rd} party API service 114 (e.g., via the internet 107), the application(s) 106 may instead send API calls to the API gateway 110. As such, the API gateway 110 may operate as a proxy for the application(s) 106 and, as indicated by arrows 109a, 109b, may forward such received API calls over the internet 107 to the 3^{rd} party API service 114, as well as forward responses the 3^{rd} party API service 114 returns to the API gateway 110 (via the internet 107) to the application(s) 106. As illustrated, in some implementations, the 3^{rd} party API service 114 may sit behind a firewall or other ingress point 111 of a private network managed by the 3^{rd} party service provider, and may employ an API gateway 115 configured to operate as a reverse proxy for one or more API services 117.

FIG. 1B shows further details of an example implementation of the system 100 shown in FIG. 1A. As indicated by arrows 102 and 104 in FIG. 1B, an application 106 may be configured to send API calls (per the arrow 102) to one or more proxy endpoints 108 of the API gateway 110, rather than to service endpoint(s) 112 of a 3rd party API service 114, and may receive responses (per the arrow 104) from those same proxy endpoints 108. In addition, as indicated by arrows 116 and 118 in FIG. 1B, the API calls sent (per the arrow 102) to the proxy endpoint(s) 108 may be forwarded (per the arrow 116) to corresponding service endpoints 112, and responses to such API calls may be sent (per the arrow 118) from those service endpoints 112 to the API gateway 110, which may then forward those responses (per the arrow 104) to the application 106.

Because the API gateway 110 sits between the application 106 and the 3rd party API service 114, the API gateway 110 may be configured to manage and/or oversee the usage of the 3rd party API service 114 by the application 106. For instance, the API gateway 110 may be configured to identify one or more particular conditions relating to the API calls passing through it (such as the receipt of one or more failure messages from the 3rd party API service 114, excessively slow responses by the 3rd party API service 114, more than a budgeted quantity and/or rate of API calls being made to the 3rd party API service 114, etc.). As indicated by arrows 120a-b in FIG. 1B, in the event the API gateway 110 determines that one or more such condition(s) are met, it may send notifications (e.g., emails, short message service (SMS) messages, Slack channel messages, etc.) to (A) one or more stakeholders 122a (e.g., application owners, service technicians, managers, etc.) affiliated with the application owner/platform team, and/or (B) one or more stakeholders 122b (e.g., application owners, service technicians, managers, etc.) affiliated with the 3rd party API service 114. Similarly, as indicated by arrows 124a-b in FIG. 1B, in the event the API gateway 110 determines that one or more such condition(s) are met, it may additionally or alternatively open one or more service tickets with (A) one or more support services 126a (e.g., Jira, Zoho Desk, etc.) affiliated with the application owner/platform team, and/or (B) one or more support services 126b (e.g., Jira, Zoho Desk, etc.) affiliated with the 3rd party API service 114.

Further, in some implementations, the API gateway 110 may additionally or alternatively be configured to take any of a number of other actions in response to determining that one or more such condition(s) are met. For instance, the API gateway 110 may begin directing API calls received at a proxy endpoint 108 to an alternate service endpoint (not illustrated in FIG. 1B) of the 3^{rd} party API service 114, or perhaps to an alternate service endpoint of a different 3^{rd} party API service (also not illustrated in FIG. 1B). As another example, the API gateway 110 may temporarily refrain from passing API calls received at a proxy endpoint 108 to the 3^{rd} party API service 114, and may instead return a particular error message to the application 106.

As noted above, some or all so the above operations of the API gateway 110 may be specified by the developer(s) of the application 106 and/or one or more other individuals responsible for the application’s performance. As shown in FIG. 1B, for example, one or more such individual(s) 128 may define “API consumption configuration data” to control the particular condition(s) that are to be monitored by the API gateway 110, as well as the actions that are to be taken by the API gateway 110 when such condition(s) are detected. An example data set defining such API consumption configuration data is described below in connection with FIG. 1C. As explained in more detail below, such API consumption configuration data may describe one or more criteria for detecting different scenarios related to errors, response times, consumption rates, etc., as well as how to respond to those scenarios by reporting, taking corrective actions where possible, etc.

As indicated by an arrow 130 in FIG. 1B, in some implementations, the API consumption configuration data may be registered with an API consumption monitoring service 132. In some implementations, such registration may be accomplished by the application developer 128 interacting with a graphical user interface (GUI), command line interface (CLI), API, or some other interface tool, of the consumption monitoring service 132. As described in more detail below, the API consumption monitoring service 132 may parse the API consumption configuration data, check it for validity and completeness, and, if everything is found satisfactory, convert it to an API gateway proxy configuration. As indicated by an arrow 134 in FIG. 1B, the API consumption monitoring service 132 may then deploy the API gateway proxy configuration to the underlying API gateway 110. Such a deployment step may include configuring the API gateway 110 such that API calls to a particular proxy endpoint 108 are redirected to a particular service endpoint 112, as well as configuring the API gateway to monitor one or more particular condition(s) and to take corresponding action(s) when such conditions are detected, as described above. Once the proxy has been successfully created on the API gateway 110, the API gateway 110 may, as indicated by an arrow 135 in FIG. 1B, provide data defining the newly-created proxy endpoint 108 to the API consumption monitoring service 132, and the API consumption monitoring service 132 may, as indicated by an arrow 137 in FIG. 1B, provide that data to the application developer 128 so that it can be provided as application configuration during deployment of the application 106. The proxy endpoint(s) 108 created on the API gateway 110 may thereafter be used by the logic of the application 106 in lieu of the service endpoint(s) 112. That is, the application 106 may thereafter make API calls exclusively to the proxy endpoint(s) 108 rather than the service endpoint(s) 112.

The API gateway 110 may thus proxy the 3rd party API service 114 and “keep an eye” on usage of the service endpoint 112 in the manner defined by the API consumption configuration data, and may take actions upon detecting issues in accordance with the directives of the application developer 128 (as also defined by the API consumption configuration data). In some implementations, the API consumption configuration data may be formatted in accordance with a consistent, standard format, regardless of the type of API gateway that is actually employed (e.g., an Azure API gateway, a Kong API gateway, an Apigee API gateway, an AWS API gateway, etc.), thus minimizing the need for the application developers to understand the inner workings of various API gateways. In such implementations, as described above, the API consumption monitoring service 132 may be responsible for automatically converting the provided API consumption configuration data into a proxy configuration for the API gateway 110 that is employed. In other implementations, the applications developers 128 may instead themselves determine the appropriate API proxy configuration that is to be deployed on the API gateway 110 (per the arrow 134 in FIG. 1B), thus obviating the need for the API consumption monitoring service 132.

An individual 128 who is developing (or modifying) an application that is to consume an API of a 3rd party API service 114 may create a data set representing the API consumption configuration data for that API. As noted, such API consumption configuration data may be based on the expectations from the 3rd party API service 114, the business impact of different failures, and various notification and/or corrective actions that the individual 128 deems appropriate. Such a data set may be formatted using extensible markup language (XML), JavaScript Object notation (JSON), YAML Ain’t Markup Language (YAML), Hypertext Markup Language (HTML), Standard Generalized Markup Language (SGML), or any other suitable format. FIG. 1C shows an example data set 136 that defines API consumption configuration data for an API an application developer 128 has named (per element 138) “Payment API for Orders App.”

As shown, the data set 136 may identify (per element 140) a uniform resource locator (URL) of a service endpoint 114 of a 3^{rd} party API service 114 to which API calls are to be sent. In addition, the data set 136 may define steps that are to be taken if one or more particular response codes are returned by the 3^{rd} party API service 114. For instance, in the illustrated example, the data set 136 indicates that if the response code “5xx” is returned (see element 142), a particular message (per element 143) is to be sent to one or more email addresses (per element 144) and/or a Slack channel (per element 146) of one or more stakeholders 122, and an incident ticket is to be opened (per elements 148 and 149) by making an API call to a URL of an API endpoint of a support service 126. As illustrated, in some implementations, the data set 136 may specify particular text and/or other information (e.g., per the elements 143, 147 and/or 149) that is to be included in such message(s) and/or incident ticket(s) to apprise the indicated stakeholder(s) 122 and/or support service(s) 126 about the nature of the deficiency indicated by the response code and/or how that deficiency is likely to impact the application 106.

As FIG. 1C also illustrates, the data set 136 may additionally or alternatively define steps that are to be taken if response times are within a particular range and/or are above a certain threshold. For instance, in the illustrated example, the data set 136 indicates that if a response time is between “2” and “5” seconds (per element 150), which is deemed to be “slow,” a particular message (per element 151) is to be sent to one or more email addresses (per element 152) and/or a Slack channel (per element 154) of one or more stakeholders 122. Similarly, in the illustrated example, the data set 136 further indicates that if a response time is greater than “5” seconds (per element 156), which is deemed to be “very slow,” a particular message (per element 157) is to be sent to one or more email addresses (per element 158) and/or a Slack channel (per element 160) of one or more stakeholders 122, and an incident ticket is additionally to be opened (per elements 162, 163) by making an API call to a URL of an API endpoint of a support service 126. Further, similar to the response code-based message(s) / support ticket(s) described above, in some implementations, the data set 136 may additionally specify particular text and/or other information (e.g., per the elements 151, 157 and/or 163) that is to be included in such message(s) and/or incident ticket(s) to apprise the indicated stakeholder(s) 122 and/or support service(s) 126 about the deficient response times and/or how those response times are likely to impact the application 106.

Further, as also shown in FIG. 1C, the data set 136 may additionally or alternatively define steps that are to be taken if the quantity and/or rate of calls to the 3rd party API service 114 exceeds a certain threshold. For instance, in the illustrated example, the data set 136 indicates that if the total number of calls made during a given time period, e.g., one week (per element 168), multiplied by a per-call cost of “$0.01” (per element 166) exceeds a consumption threshold of “$1000” per week (per element 164), a particular message (per element 169) is to be sent to one or more email addresses (per element 170). As also illustrated, similar to the other message(s) / support ticket(s) described above, in some implementations, the data set 136 may additionally specify particular text and/or other information (e.g., per the element 169) that is to be included in such message(s) to apprise the indicated stakeholder(s) 122 about the threshold that has been exceeded and/or the impact of that overage.

And still further, in some implementations, the data set 136 may additionally indicate (e.g., per element 172) whether notification(s) are to be sent only a single time in connection with multiple incidents that occur within a certain period of time (e.g., one hour), as opposed to being sent every time such an incident is detected. Similarly, in some implementations, the data set 136 may indicate (e.g., per element 174) whether only a single incident ticket is to be created in connection with multiple incidents that occur within a particular time period (e.g., one hour), as opposed to being opened every time such an incident is detected.

Additional details and example implementations of embodiments of the present disclosure are set forth below in Section E, following a description of example systems and network environments in which such embodiments may be deployed.

### B. Network Environment

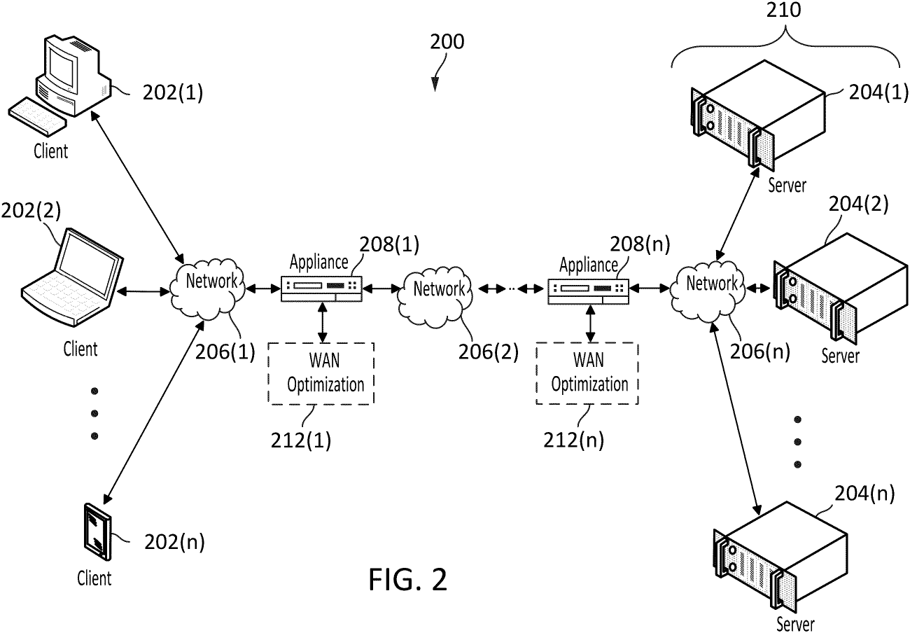

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, FL, such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, FL, such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

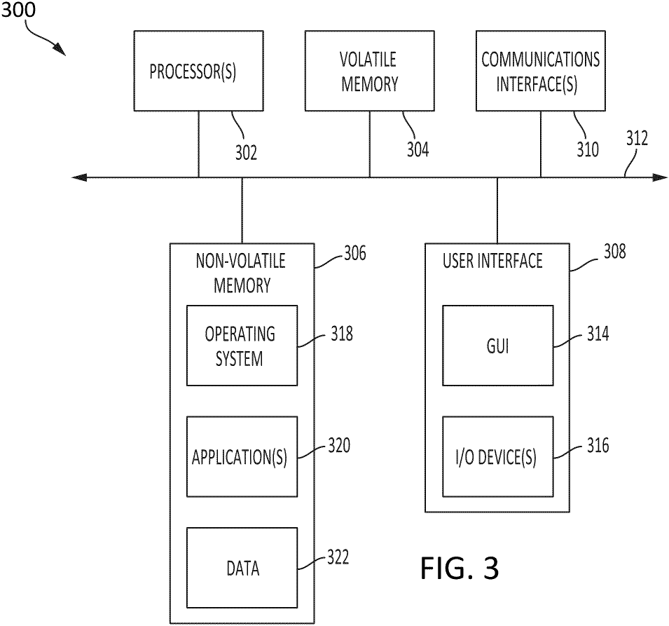

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

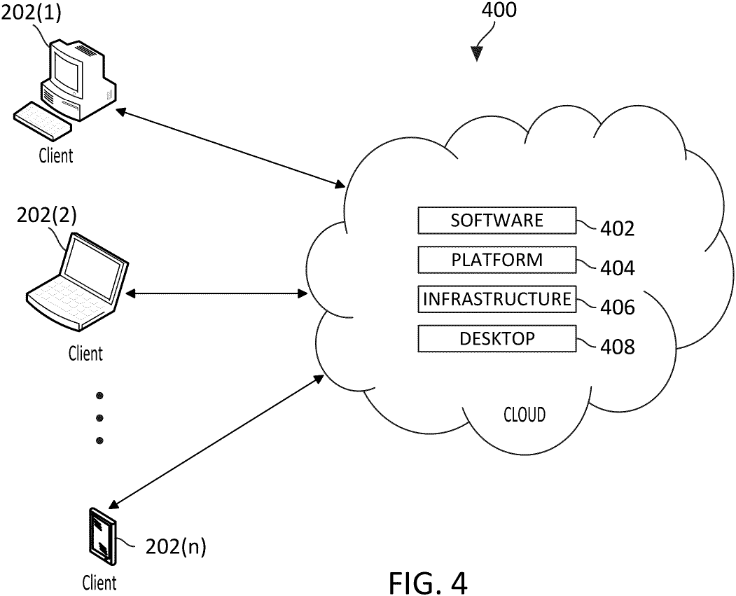

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS platforms include AMAZON WEB SERVICES provided by Amazon.com, Inc., of Seattle, Washington, Azure IaaS provided by Microsoft Corporation or Redmond, Washington, RACKSPACE CLOUD provided by Rackspace US, Inc., of San Antonio, Texas, Google Compute Engine provided by Google Inc. of Mountain View, California, and RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. Citrix ShareFile® from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California. Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Washington, or AMAZON WEB SERVICES provided by Amazon.com, Inc., of Seattle, Washington, for example. In the case of Citrix Cloud, Citrix Workspace app may be used as a single-entry point for bringing apps, files and desktops together (whether on-premises or in the cloud) to deliver a unified experience.

### E. Detailed Description of Example Embodiments of a System for Enabling the Intelligent Consumption of APIs

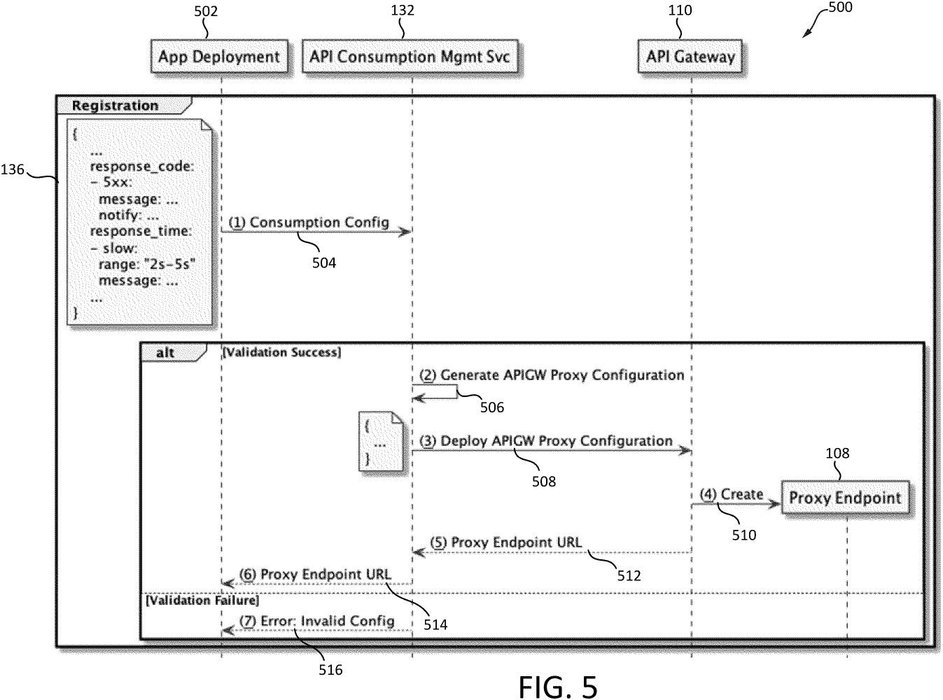

As described above in connection with FIGS. 1A-C (in Section A), an API consumption monitoring service 132 may be configured to receive, as input, a data set 136 defining API consumption configuration data for a service endpoint 112 of a 3^{rd} party API service 114, and to provide, as output, data defining a proxy endpoint 108 (e.g., a URL of the proxy endpoint 108) for that service endpoint 112. FIG. 5 shows a sequence diagram 500 illustrating example actions that may be taken by and amongst various computing systems to achieve that functionality. In addition to the API consumption monitoring service 132 and the API gateway 110, both of which are illustrated in FIG. 1B, FIG. 5 shows a computing system 502 (labeled “App Deployment”) that may be operated, for example, by the application developer 128 shown in FIG. 1B. The respective computing systems shown in FIG. 5 (i.e., the app deployment system 502, the API consumption monitoring service 132, and the API gateway 110) may be embodied, for example, by one or more the clients 202, one or more the servers 204, and/or one or more components of the cloud computing environment 400 that are described above in connection with FIGS. 2-4.

As shown in FIG. 5, the app deployment system 502 may send (504) the data set 136 defining API consumption configuration data to the API consumption monitoring service 132. For example, as noted above, in some implementations, the application developer 128 may operate the app deployment system 502 to interact with a graphical user interface (GUI), a command line interface (CLI), an API, or some other interface tool, of the API consumption monitoring service 132 by inputting the data set 136 and requesting the creation of an API proxy endpoint 108 based on that data set 136. As shown in FIG. 5, the API consumption monitoring service 132 may process (506) the received data set 136, such as by parsing the API consumption configuration data, checking it for validity and completeness, and, if everything is found satisfactory, using it to generate an API gateway (APIGW) proxy configuration.

If the API consumption monitoring service 132 determines the API consumption configuration defined by the data set 136 is valid and complete, e.g., by determining that the data set 136 defines the requisite features for a proxy configuration and includes logically-consistent parameters, valid addresses, etc., then the API consumption monitoring service 132 may deploy (508) the API proxy configuration to the API gateway 110, and the API gateway 110 may create (510) a new proxy endpoint 108 for the service endpoint 112 of the 3^{rd} party API service 114. That is, the API gateway 110 may generate a unique uniform resource locator (URL) for the new proxy endpoint 108 which, when called by the application 106, will cause the API gateway 110 to forward the call to a corresponding service endpoint 112. If, on the other hand, the API consumption monitoring service 132 determines the data set 136 is invalid or insufficient in some way, then the API consumption monitoring service 132 may instead return (516) an error message to the app deployment system 502.

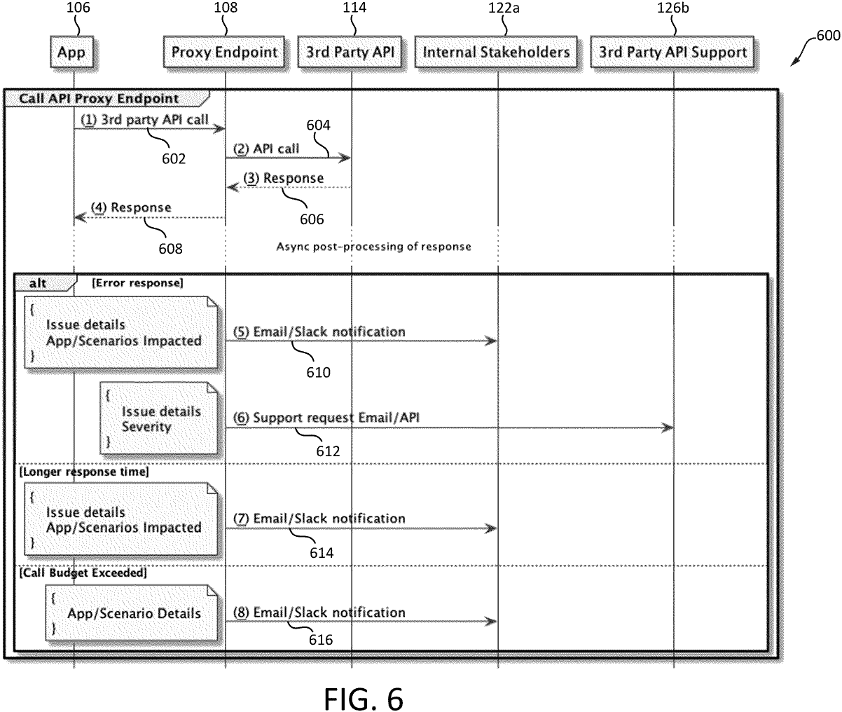

When a proxy endpoint 108 is successfully created on the API gateway 110, the API gateway 110 may send (512) data defining the newly-created proxy endpoint 108 (e.g., a URL of the proxy endpoint 108) to the API consumption monitoring service 132, and the API consumption monitoring service 132 may, in turn, send (514) that data to the app deployment system 502, where it can be used by the application developer 128 to configure the application 106 to make API calls to the proxy endpoint 108, such as described below in connection with FIG. 6.

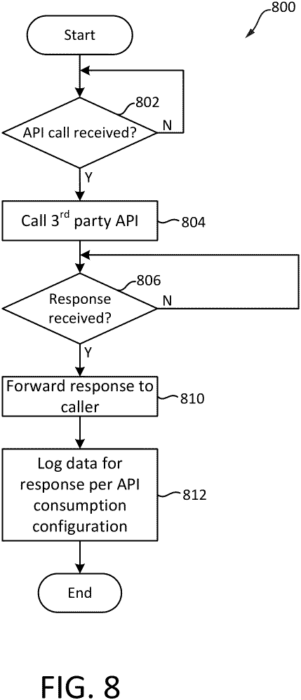

FIG. 6 shows a sequence diagram 600 illustrating actions that may be taken by and amongst various components shown in FIG. 1B, after the proxy endpoint 108 has been deployed on the API gateway 110 (as described above in connection with FIG. 5), and after the application 106 has been configured to make API calls to the proxy endpoint 108. As shown, upon deployment, the application 106 may send (602) an API call to the proxy endpoint 108 on the API gateway 110, instead of directly calling the 3^{rd} party API 114 service, e.g., via a service endpoint 112. The proxy endpoint 108 may forward (604) the API call received from the application 106 to the 3^{rd} party API service 114, and the 3^{rd} party API service 114 may return (606) a response to the API call. The proxy endpoint 108 may then forward (608) the received response to the application 106. As shown in FIG. 6, the API gateway 110 may additionally evaluate the response received from the 3^{rd} party API service 114 to determine whether one or more conditions (specified by the API consumption configuration data that was used to configure the proxy endpoint 108) are satisfied. As shown, in some implementations, such evaluation may be performed asynchronously with the receipt of the response from the 3^{rd} party API service 114, e.g., at some point in time after the response has been received from the 3^{rd} party API service 114. In other implementations, the evaluation for specified conditions may instead be performed synchronously with the receipt of responses from the 3^{rd} party API service 114. Examples of triggering events for performing such evaluation for specified conditions are described below in connection with FIG. 8.

As shown in FIG. 6, upon detecting that one or more specified conditions are met, the API gateway 110 may take various actions. Examples of actions that may be taken for three different conditions are indicated in the depicted example. First, upon detecting that the response from the 3^{rd} party API service 114 included a particular error code, the API gateway 110 may send (610) one or more notifications (e.g., emails and/or Slack notifications) concerning the error to one or more stakeholders 122a affiliated with the owner of the application 106, and/or may open (612) a support ticket and/or send (612) one or more support-related notifications to support personnel. Second, upon detecting a response time within a range of times and/or in excess of a threshold time, the API gateway 110 may send (614) one or more notifications (e.g., emails and/or Slack notifications) concerning the slow response to one or more stakeholders 122a affiliated with the owner of the application 106. Third, upon detecting that the quantity and/or rate of API calls to the 3^{rd} party API service 114 is beyond or approaching a particular quantity and/or rate (or related consumption threshold) , the API gateway 110 may send (616) one or more notifications (e.g., emails and/or Slack notifications) concerning the overage to one or more stakeholders 122a affiliated with the owner of the application 106.

It should be appreciated that the actions shown in FIG. 6 represent only a handful of examples of actions that may be taken by the API gateway 110 based the detection of particular conditions, and that any of a number of other actions may additionally or alternatively be taken in various scenarios. Further, as explained in more detail below in connection with FIG. 8, in some implementations, the evaluation of data indicative of responses received from the 3^{rd} party API service 114 may be performed by a computing system other than the API gateway 110. For instance, in some implementations, the API gateway 110 may be responsible for logging pertinent telemetry data concerning responses it receives from the 3^{rd} party API service 114, and another computing system may be responsible for retrieving and evaluating that telemetry data to determine whether one or more conditions are satisfied, as well as for taking one or more actions when pertinent conditions are determined to exist. As with the other implementation discussed above, the logic underlying such evaluation and processing by such separate computing system may be based on API consumption configuration data, e.g., as defined by the data set 136 described above.

Since calls to the 3^{rd} party API service 114 are made via the API gateway 110 and the proxy is configured to handle pertinent scenarios as per the requirements of the application 106 (e.g., as defined by the API consumption configuration data), there is no burden on the application 106 to do that processing, which may help keep application code clean. Further, any issues in the 3rd party API service 114, when they manifest, may be handled as close as possible to the point of issue, and remedial actions may be taken promptly instead of waiting for issues to manifest in the application logic.

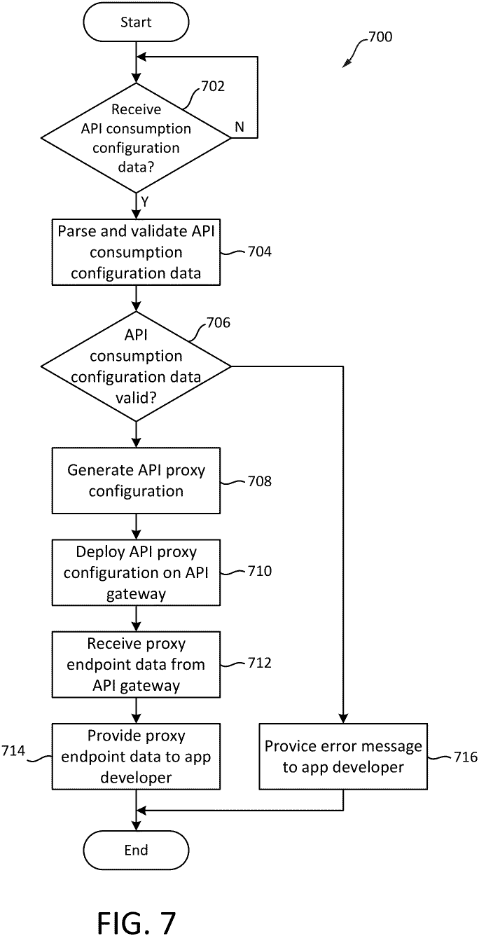

FIG. 7 shows an example routine 700 that may be performed by the API consumption monitoring service 132 shown in FIG. 1B. In some implementations, the API consumption monitoring service 132 may be a computing system that includes one or more processors and one or more computer-readable media encoded with instructions which, when executed by the one or more processors, cause the computing system to perform some or all of the routine 700.

As shown in FIG. 7, the routine 700 may begin at a decision step 702, when the API consumption monitoring service 132 receives API consumption configuration data (e.g., as defined by the data set 136 shown in FIG. 1C) from another computing system, such as a computing device operated by an application developer 128.

At a step 704 of the routine 700, the API consumption monitoring service 132 may parse the received API consumption configuration data and evaluate the data to determine whether it is complete and valid.

At a decision step 706 of the routine 700, the API consumption monitoring service 132 may determine whether, based on the analysis performed at the step 704, the API consumption configuration data is valid. When, at the decision step 706, the API consumption monitoring service 132 determines the data is incomplete or otherwise invalid, the routine 700 may proceed to a step 716, at which the API consumption monitoring service 132 may send an error message to the computing device operated by the application developer 128 or otherwise apprise the application developer 128 that the API consumption configuration data cannot be used to create a proxy endpoint 108. When, on the other hand, the API consumption monitoring service 132 determines (at the decision step 706) that the received API consumption configuration data is valid, the routine may instead proceed to a step 708, at which the API consumption monitoring service 132 may generate an API proxy configuration for the service endpoint 112 indicated in the API consumption configuration data.

At a step 710 of the routine 700, the API consumption monitoring service 132 may deploy the API proxy configuration (generated at the step 708) on the API gateway 110.

At a step 712 of the routine 700, the API consumption monitoring service 132 may receive data indicative of a proxy endpoint 108 created on the API gateway 110 (e.g., a URL of the proxy endpoint) from the API gateway 110.

At a step 714 of the routine 700, the API consumption monitoring service 132 may provide the proxy endpoint data (e.g., a URL of the newly-created proxy endpoint 108) to the application developer 128, thus allowing the application developer to use the proxy endpoint data to configure the application 106 to make API calls to the proxy endpoint 108.

FIG. 8 shows a first example routine 800 that may be performed by the API gateway 110 shown in FIG. 1. In some implementations, the API gateway 110 may be a computing system that includes one or more processors and one or more computer-readable media encoded with instructions which, when executed by the one or more processors, cause the computing system to perform some or all of the routine 800. Further, in some implementations, the API gateway 110 may be implemented within a cloud computing environment, and may, for example, correspond to an Azure API gateway, a Kong API gateway, an Apigee API gateway, an AWS API gateway, etc.

As shown in FIG. 8, the routine 800 may begin when, at a decision step 802, the API gateway 110 receives an API call to the proxy endpoint 108, e.g., from the application 106.

At a step 804 of the routine 800, the API gateway 110 may forward the API call (received per the decision step 802) to the service endpoint 112 of the 3^{rd} party API service 114. Per a decision step 806, the API gateway 110 may then await a response from the 3^{rd} party API service 114.

Upon receipt of a response (per the decision step 806), the API gateway 110 may, at a step 810, forward the response to the computing system that sent the API call to the proxy endpoint 108, e.g., the computing system executing the application 106.

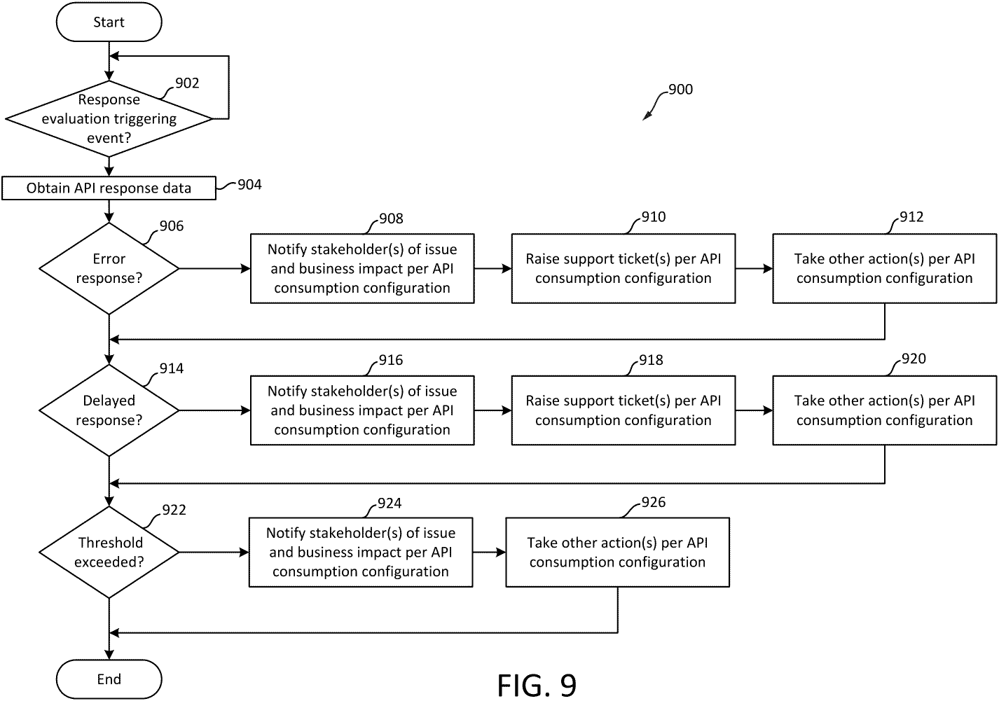

At a step 812 of the routine 800, the API gateway 110 may log or otherwise store data indicative of the response that was received from the 3^{rd} party API service 114, so that such data may subsequently be evaluated by the API gateway 110 (or, alternatively, by another computing system) to determine whether one or more actions are to be taken when certain conditions are met (e.g., as described below in connection with FIG. 9).

FIG. 9 shows a second example routine 900 that may be performed by the API gateway 110 shown in FIG. 1 (or another computing system). As noted above, in some implementations, the API gateway 110 may be a computing system that includes one or more processors and one or more computer-readable media encoded with instructions which, when executed by the one or more processors, cause the computing system to perform some or all of the routine 900. Further, as also noted above, in some implementations, the API gateway 110 may be implemented within a cloud computing environment, and may, for example, correspond to an Azure API gateway, a Kong API gateway, an Apigee API gateway, an AWS API gateway, etc. Alternatively, as explained in more detail below, in some implementations, the routine 900 may instead be performed by a computing system that is separate from, but in communication with, the API gateway 110.

As shown in FIG. 9, the routine 900 may begin when, at a decision step 902, the API gateway 110 (or another computing system in communication with the API gateway 110) determines that a triggering event for evaluating responses from the 3^{rd} party API service 114 (e.g., logged per the step 812 of the routine 800 - shown in FIG. 8) has occurred. In some implementations, a triggering event (per the decision step 902) may include the receipt of a new response from the 3^{rd} party API service 114, such that the evaluation process is synchronized with received responses. In other implementations, triggering events (per the decision step 902) may additionally or alternatively include certain times of day, e.g., the top of every hour. In still other implementations, a triggering event may additionally or alternatively include the expiration of particular time interval (e.g., ten minutes) since the most recent triggering event. In yet other implementations, a trigger event may additionally or alternatively include some other occurrence detected by the API gateway 110 (or another computing system in communication with the API gateway 110) asynchronously with the receipt of responses from the 3^{rd} party API service 114.

At a step 904 of the routine 900, the API gateway 110 (or another computing system in communication with the API gateway 110) may obtain pertinent data (e.g., logged per the step 812 of the routine 800 - shown in FIG. 8) concerning responses from the 3^{rd} party API service 114. In implementations in which the routine 900 is performed by the API gateway 110 itself, the step 904 may simply involve referencing or retrieving locally stored data. In implementations in which the routine 900 is performed by another computing system, the step 904 may instead involve that other computing system retrieving API response data from a remote data storage medium(e.g., a database, cache, log file, etc.) associated with the API gateway 110, in which that response data was logged.

At a decision step 906, the API gateway 110 (or other computing system) may determine whether one or more responses received from the 3^{rd} party API service 114 by the proxy endpoints 108 include an indication of an error encountered by the 3^{rd} party API service 114, e.g., by including one or more particular error codes. As shown, when the API gateway 110 (or other computing system) determines (at the decision step 906) that such response(s) included such indication(s), e.g., error code(s), the routine 900 may proceed to steps 908, 910, and 912, at which the API gateway 110 (or other computing system) may take one or more particular actions in response to detection of such indication(s). In particular, at the step 908, the API gateway 110 (or other computing system) may notify one or more stakeholders 122a-b (e.g., via email, Slack channel, etc.) about the issue(s) indicated by the error indications(s) as well as the potential business impact of such issue(s). In some implementations, such notifications may be generated by making one or more API calls to appropriate messaging applications or services. As noted above, in some implementations, one or more particular error codes that are to prompt the sending of notifications to particular stakeholders 122a-b, as well as the email addresses, Slack channels, etc., to which such notifications are to be sent may have been specified in the API consumption configuration data that was used to generate the proxy configuration for the proxy endpoint 108 to which such response(s) were directed.

At the step 910 of the routine 900, the API gateway 110 (or other computing system) may raise one or more support tickets for the issue(s) indicated by the indication(s), e.g., error code(s), such as by making appropriate API calls to one or more support services 126a-b. As noted above, in some implementations, particular error codes that are to prompt the raising of support tickets may have been specified in the API consumption configuration data that was used to generate the proxy configuration for the proxy endpoint 108 to which such response(s) were directed.

Finally, at the step 912 of the routine 900, the API gateway 110 (or other computing system) may take one or more other actions to address the issue(s) indicated by the indication(s), e.g., error code(s). For example, in some implementations, in response to detecting one or more particular issues, the API gateway 110 may begin directing (or the other computing system may instruct the API gateway to direct) API calls received at the proxy endpoint 108 to an alternate service endpoint of the 3^{rd} party API service 114, or perhaps to an alternate service endpoint of a different 3^{rd} party API service. As another example, the API gateway 110 may temporarily refrain (or the other computing system may instruct the API gateway 110 to temporarily refrain) from passing API calls received at a proxy endpoint 108 to the 3^{rd} party API service 114, and may instead return a particular error message to the application 106.

At a decision step 914, the API gateway 110 (or other computing system) may determine whether a potentially problematic delay occurred between the sending of one or more API calls to the service endpoint 112 of the 3^{rd} party API service 114 and the receipt of response(s) to such call(s). As shown, when the API gateway 110 (or other computing system) determines (at the decision step 914) that one or more response(s) were delayed in some fashion, the routine 900 may proceed to steps 916, 918, and 920, at which the API gateway 110 (or other computing system) may take one or more particular actions in response to detection of such delayed response(s). As described above, in some implementations, a response time within a certain time range may be considered a “slow” response whereas a response time above a threshold time period may be considered a “very slow” response, and those two situations may result in different actions being taken per the steps 916, 918, and 920. The types of actions that may be taken at the steps 916, 918, and 920 are similar to the types of actions described above in connection with the steps 908, 910, and 912, respectively.

At a decision step 922, the API gateway 110 (or other computing system) may determine whether the quantity and/or rate of API calls made to the 3^{rd} party API service has exceeded (or nearly exceeded) a budgeted quantity and/or rate (or related consumption threshold for the same). As shown, when the API gateway 110 (or other computing system) determines (at the decision step 922) that a such a threshold for the application has been exceeded (or nearly exceeded), the routine 900 may proceed to steps 924 and 926, at which the API gateway 110 (or other computing system) may take one or more particular actions in response to that determination. The types of actions that may be taken at the steps 924 and 926 are similar to the types of actions described above in connection with the steps 908 and 912, respectively.

Using the above techniques, when issues are observed in the 3^{rd} party API responses, it is possible to know the exact business impact because it was provided by the developer of the application 106 as part of the API consumption configuration specified by the data set 136 and, as such, was likewise specified in the proxy configuration deployed on the API gateway 110. Another major advantage of the solution is that when policies related to 3^{rd} party API consumption change, the proxy configuration can be seamlessly updated without touching the application code at all. All that would need to be done to change the proxy configuration would be to change the data set 136 to define modified API consumption configuration data and to re-register the updated configuration with the API consumption monitoring service 132.

The API consumption configuration data (e.g., as defined by the data set 136) may be created by the application developer 128 who is well versed on the dependency on the 3^{rd} party API service 114, the use-cases served by the application 106, and the business impact of 3^{rd} party API issues on that application 106. This enables pinpointing of the specific impact when an issue is observed with 3^{rd} part API functioning.

The proxy endpoint 108 created on the API gateway 110 may pass through parameters on the request and response paths so that the application logic doesn’t have to change because of the introduction of proxy endpoint 108.

In some implementations, the number of instances of an issue detected by the API gateway 110 may be counted, and actions may be performed (as described above) only if a threshold number of such issues are detected within a certain time period. Similarly, in some implementations, the number of instances of an issue across multiple applications using the same 3^{rd} party API may be counted, and actions may be performed (as described above) only if the cumulative number of such issues detected within a certain time period exceeds a threshold. In such cases the impact reported may be consolidation of impact from individual applications.

In some implementations, the techniques disclosed herein may additionally be used to determine transitive impacts amongst applications. For example, assume that Application C is a 3^{rd} party API service, and it is know from API consumption configuration data that Application A calls Application B, that Application B calls Application C, and that Application X also calls application C. When a failure is seen in Application C, e.g., based on an error code that is returned by application C when application B tries to call it, knowledge of that failure may be transitively applied to determine and report an adverse impact on Application A, and to also determine and report an adverse on Application X.

### F. Example Implementations of Methods, Systems, and Computer-Readable Media in Accordance with the Present Disclosure

The following paragraphs (M1) through (M21) describe examples of methods that may be implemented in accordance with the present disclosure.

(M1) A method may be performed that involves receiving, at a first application programming interface (API) endpoint of a first computing system positioned before an egress point of a private network in which an application is executing, an API call from the application; sending, by the first computing system, the API call over the internet to a second API endpoint; and initiating at least a first action based at least in part on a response to the API call being indicative of a deficiency in execution of the API call by the second API endpoint.

(M2) A method may be performed as described in paragraph (M1), and may further involve configuring the first computing system with the first API endpoint to proxy API calls to the second API endpoint.

(M3) A method may be performed as described in paragraph (M2), wherein configuring the first computing system may involve receiving, by a second computing system, data defining at least the second API endpoint, at least one criterion for determining that the response is indicative of the deficiency, and the first action; generating, by the second computing system and using the data, a proxy configuration for the second API endpoint, the proxy configuration including the first API endpoint; deploying, by the second computing system, the proxy configuration on the first computing system; and sending, from the second computing system to a remote computing device, an indicator of the first API endpoint for use by the application.

(M4) A method may be performed as described in any of paragraphs (M1) through (M3), and may further involve determining to initiate the first action based at least in part on an error code of the response to the API call matching a first value.

(M5) A method may be performed as described in any of paragraphs (M1) through (M4), and may further involve determining to initiate the first action based at least in part on a duration of time between sending a the API call to the second API endpoint and receipt of the response to the API call from the second API endpoint exceeding a threshold value.

(M6) A method may be performed as described in any of paragraphs (M1) through (M5), wherein initiating the first action may further involve causing a notification of the deficiency to be sent to at least one individual.

(M7) A method may be performed as described in any of paragraphs (M1) through (M6), wherein initiating the first action may further involve causing a trouble ticket to be opened with at least one support service.

(M8) A method may be performed as described in any of paragraphs (M1) through (M7), and may further involve causing at least one notification to be sent to at least a first individual based at least in part on a first operational characteristic of the first API endpoint meeting a first criterion.

(M9) A method may performed that involves receiving, at a first application programming interface (API) endpoint of a first computing system positioned before an egress point of a private network in which an application is executing , API calls from the application; sending, by the first computing system, the API calls over the internet to a second API endpoint; and causing at least one notification to be sent to at least a first individual based at least in part on a first operational characteristic of the first API endpoint meeting a first criterion.

(M10) A method may be performed as described in paragraph (M9), and may further involve configuring the first computing system with the first API endpoint to proxy the API calls to the second API endpoint.

(M11) A method may be performed as described in paragraph (M10), wherein configuring the first computing system may involve receiving, by a second computing system, data defining at least the second API endpoint, the first operational characteristic, the first criterion, and an indicator of a destination for notifications to the first individual; generating, by the second computing system and using the data, a proxy configuration for the second API endpoint, the proxy configuration including the first API endpoint; deploying, by the second computing system, the proxy configuration on the first computing system; and sending, from the second computing system to a remote computing device, an indicator of the first API endpoint for use by the application.

(M12) A method may be performed as described in any of paragraphs (M9) through (M11), wherein the first operational characteristic may comprise a quantity of the API calls sent to the second API endpoint, and the method may further involve determining the quantity of the API calls sent to the second API endpoint.

(M13) A method may be performed as described in paragraph (M12), and may further involve determining, based at least in part on the quantity of API calls sent to the second API endpoint, that a rate at which API calls are being made to the second API endpoint has exceeded a threshold.

(M14) A method may be performed that involves receiving, at a first application programming interface (API) endpoint of a first computing system positioned before an egress point of a private network in which an application is executing, an API call from the application; sending, by the first computing system, the API call over the internet to a second API endpoint; receiving, by the first computing system and from the second API endpoint, a response to the API call; and initiating at least a first action based at least in part on a response to the API call being indicative of a deficiency in execution of the API call by the second API endpoint.

(M15) A method may be performed as described in paragraph (M14), and may further involve configuring the first computing system with the first API endpoint to proxy API calls to the second API endpoint.

(M16) A method may be performed as described in paragraph (M14) or paragraph (M15), and may further involve receiving, by a second computing system, data defining at least the second API endpoint, at least one criterion for determining that the response is indicative of the deficiency, and the first action; generating, by the second computing system and using the data, a proxy configuration for the second API endpoint, the proxy configuration including the first API endpoint; deploying, by the second computing system, the proxy configuration on the first computing system; and sending, from the second computing system to a remote computing device, an indicator of the first API endpoint for use by the application.

(M17) A method may be performed as described in any of paragraphs (M14) through (M16), and may further involve determining to initiate the first action based at least in part on an error code of the response to the API call matching a first value.

(M18) A method may be performed as described in paragraph (M17), wherein determining to initiate the first action may further involve determining to initiate the first action based at least in part on a duration of time between sending a the API call to the second API endpoint and receipt of the response to the API call from the second API endpoint exceeding a threshold value.

(M19) A method may be performed as described in any of paragraphs (M14) through (M18), and may further involve causing a notification of the deficiency to be sent to at least one individual.

(M20) A method may be performed as described in any of paragraphs (M14) through (M19), and may further involve causing a trouble ticket to be opened with at least one support service.

(M21) A method may be performed as described in any of paragraphs (M14) through (M20), and may further involve causing at least one notification to be sent to at least a first individual based at least in part on a first operational characteristic of the first API endpoint meeting a first criterion.

The following paragraphs (S1) through (S21) describe examples of systems and devices that may be implemented in accordance with the present disclosure.

(S1) A system may comprise at least one processor and at least one computer-readable medium encoded with instructions which, when executed by the at least one processor, cause the system to receive, at a first application programming interface (API) endpoint of a first computing system positioned before an egress point of a private network in which an application is executing, an API call from the application; to send, by the first computing system, the API call over the internet to a second API endpoint; and to initiate at least a first action based at least in part on a response to the API call being indicative of a deficiency in execution of the API call by the second API endpoint.

(S2) A system may be configured as described in paragraph (S1), wherein the at least one computer-readable medium may be encoded with additional instructions which, when executed by the at least one processor, further cause the system to configure the first computing system with the first API endpoint to proxy API calls to the second API endpoint.

(S3) A system may be configured as described in paragraph (S2), wherein the at least one computer-readable medium may be encoded with additional instructions which, when executed by the at least one processor, further cause the system to configure the first computing system at least in part by receiving, by a second computing system, data defining at least the second API endpoint, at least one criterion for determining that the response is indicative of the deficiency, and the first action; generating, by the second computing system and using the data, a proxy configuration for the second API endpoint, the proxy configuration including the first API endpoint; deploying, by the second computing system, the proxy configuration on the first computing system; and sending, from the second computing system to a remote computing device, an indicator of the first API endpoint for use by the application.

(S4) A system may be configured as described in any of paragraphs (S1) through (S3), wherein the at least one computer-readable medium may be encoded with additional instructions which, when executed by the at least one processor, further cause the system to determine to initiate the first action based at least in part on an error code of the response to the API call matching a first value.

(S5) A system may be configured as described in any of paragraphs (S1) through (S4), wherein the at least one computer-readable medium may be encoded with additional instructions which, when executed by the at least one processor, further cause the system to determine to initiate the first action based at least in part on a duration of time between sending a the API call to the second API endpoint and receipt of the response to the API call from the second API endpoint exceeding a threshold value.

(S6) A system may be configured as described in any of paragraphs (S1) through (S5), wherein the at least one computer-readable medium may be encoded with additional instructions which, when executed by the at least one processor, further cause the system to initiate the first action at least in part by causing a notification of the deficiency to be sent to at least one individual.

(S7) A system may be configured as described in any of paragraphs (S1) through (S6), wherein the at least one computer-readable medium may be encoded with additional instructions which, when executed by the at least one processor, further cause the system to initiate the first action at least in part by causing a trouble ticket to be opened with at least one support service.

(S8) A system may be configured as described in any of paragraphs (S1) through (S7), wherein the at least one computer-readable medium may be encoded with additional instructions which, when executed by the at least one processor, further cause the system to cause at least one notification to be sent to at least a first individual based at least in part on a first operational characteristic of the first API endpoint meeting a first criterion.

(S9) A system may comprise at least one processor and at least one computer-readable medium encoded with instructions which, when executed by the at least one processor, cause the system to receive, at a first application programming interface (API) endpoint of a first computing system positioned before an egress point of a private network in which an application is executing, API calls from the application; to send, by the first computing system, the API calls over the internet to a second API endpoint; and to cause at least one notification to be sent to at least a first individual based at least in part on a first operational characteristic of the first API endpoint meeting a first criterion.

(S10) A system may be configured as described in paragraph (S9), wherein the at least one computer-readable medium may be encoded with additional instructions which, when executed by the at least one processor, further cause the system to configure the first computing system with the first API endpoint to proxy the API calls to the second API endpoint.

(S11) A system may be configured as described in paragraph (S10), wherein the at least one computer-readable medium may be encoded with additional instructions which, when executed by the at least one processor, further cause the system to configure the first computing system at least in part by receiving, by a second computing system, data defining at least the second API endpoint, the first operational characteristic, the first criterion, and an indicator of a destination for notifications to the first individual; generating, by the second computing system and using the data, a proxy configuration for the second API endpoint, the proxy configuration including the first API endpoint; deploying, by the second computing system, the proxy configuration on the first computing system; and sending, from the second computing system to a remote computing device, an indicator of the first API endpoint for use by the application.

(S12) A system may be configured as described in any of paragraphs (S9) through (S11), wherein the first operational characteristic may comprise a quantity of the API calls sent to the second API endpoint, and the at least one computer-readable medium may be encoded with additional instructions which, when executed by the at least one processor, further cause the system to determine the quantity of the API calls sent to the second API endpoint.

(S13) A system may be configured as described in paragraph (S12), wherein the at least one computer-readable medium may be encoded with additional instructions which, when executed by the at least one processor, further cause the system to determine, based at least in part on the quantity of API calls sent to the second API endpoint, that a rate at which API calls are being made to the second API endpoint has exceeded a threshold.

(S14) A system may comprise at least one processor and at least one computer-readable medium encoded with instructions which, when executed by the at least one processor, cause the system to receive, at a first application programming interface (API) endpoint of a first computing system positioned before an egress point of a private network in which an application is executing, an API call from the application; to send, by the first computing system, the API call over the internet to a second API endpoint; to receive, by the first computing system and from the second API endpoint, a response to the API call; and to initiate at least a first action based at least in part on a response to the API call being indicative of a deficiency in execution of the API call by the second API endpoint.

(S15) A system may be configured as described in paragraph (S14), wherein the at least one computer-readable medium may be encoded with additional instructions which, when executed by the at least one processor, further cause the system to configure the first computing system with the first API endpoint to proxy API calls to the second API endpoint.

(S16) A system may be configured as described in paragraph (S14) or paragraph (S15), wherein the at least one computer-readable medium may be encoded with additional instructions which, when executed by the at least one processor, further cause the system to receive, by a second computing system, data defining at least the second API endpoint, at least one criterion for determining that the response is indicative of the deficiency, and the first action; to generate, by the second computing system and using the data, a proxy configuration for the second API endpoint, the proxy configuration including the first API endpoint; to deploy, by the second computing system, the proxy configuration on the first computing system; and to send, from the second computing system to a remote computing device, an indicator of the first API endpoint for use by the application.

(S17) A system may be configured as described in any of paragraphs (S14) through (S16), wherein the at least one computer-readable medium may be encoded with additional instructions which, when executed by the at least one processor, further cause the system to determine to initiate the first action based at least in part on an error code of the response to the API call matching a first value.

(S18) A system may be configured as described in paragraph (S17), wherein the at least one computer-readable medium may be encoded with additional instructions which, when executed by the at least one processor, further cause the system to determine to initiate the first action based at least in part on a duration of time between sending a the API call to the second API endpoint and receipt of the response to the API call from the second API endpoint exceeding a threshold value.

(S19) A system may be configured as described in any of paragraphs (S14) through (S18), wherein the at least one computer-readable medium may be encoded with additional instructions which, when executed by the at least one processor, further cause the system to cause a notification of the deficiency to be sent to at least one individual.

(S20) A system may be configured as described in any of paragraphs (S14) through (S19), wherein the at least one computer-readable medium may be encoded with additional instructions which, when executed by the at least one processor, further cause the system to cause a trouble ticket to be opened with at least one support service.

(S21) A system may be configured as described in any of paragraphs (S14) through (S20), wherein the at least one computer-readable medium may be encoded with additional instructions which, when executed by the at least one processor, further cause the system to cause at least one notification to be sent to at least a first individual based at least in part on a first operational characteristic of the first API endpoint meeting a first criterion.

The following paragraphs (CRM1) through (CRM21) describe examples of computer-readable media that may be implemented in accordance with the present disclosure.

(CRM1) At least one non-transitory computer-readable medium may be encoded with instructions which, when executed by at least one processor of a system, cause the system to receive, at a first application programming interface (API) endpoint of a first computing system positioned before an egress point of a private network in which an application is executing, an API call from the application; to send, by the first computing system, the API call over the internet to a second API endpoint; and to initiate at least a first action based at least in part on a response to the API call being indicative of a deficiency in execution of the API call by the second API endpoint.

(CRM2) At least one non-transitory computer-readable medium may be configured as described in paragraph (CRM1), and may be encoded with additional instructions which, when executed by the at least one processor, further cause the system to configure the first computing system with the first API endpoint to proxy API calls to the second API endpoint.

(CRM3) At least one non-transitory computer-readable medium may be configured as described in paragraph (CRM2), and may be encoded with additional instructions which, when executed by the at least one processor, further cause the system to configure the first computing system at least in part by receiving, by a second computing system, data defining at least the second API endpoint, at least one criterion for determining that the response is indicative of the deficiency, and the first action; generating, by the second computing system and using the data, a proxy configuration for the second API endpoint, the proxy configuration including the first API endpoint; deploying, by the second computing system, the proxy configuration on the first computing system; and sending, from the second computing system to a remote computing device, an indicator of the first API endpoint for use by the application.

(CRM4) At least one non-transitory computer-readable medium may be configured as described in any of paragraphs (CRM1) through (CRM3), and may be encoded with additional instructions which, when executed by the at least one processor, further cause the system to determine to initiate the first action based at least in part on an error code of the response to the API call matching a first value.

(CRM5) At least one non-transitory computer-readable medium may be configured as described in any of paragraphs (CRM1) through (CRM4), and may be encoded with additional instructions which, when executed by the at least one processor, further cause the system to determine to initiate the first action based at least in part on a duration of time between sending a the API call to the second API endpoint and receipt of the response to the API call from the second API endpoint exceeding a threshold value.

(CRM6) At least one non-transitory computer-readable medium may be configured as described in any of paragraphs (CRM1) through (CRM5), and may be encoded with additional instructions which, when executed by the at least one processor, further cause the system to initiate the first action at least in part by causing a notification of the deficiency to be sent to at least one individual.

(CRM7) At least one non-transitory computer-readable medium may be configured as described in any of paragraphs (CRM1) through (CRM6), and may be encoded with additional instructions which, when executed by the at least one processor, further cause the system to initiate the first action at least in part by causing a trouble ticket to be opened with at least one support service.

(CRM8) At least one non-transitory computer-readable medium may be configured as described in any of paragraphs (CRM1) through (CRM7), and may be encoded with additional instructions which, when executed by the at least one processor, further cause the system to cause at least one notification to be sent to at least a first individual based at least in part on a first operational characteristic of the first API endpoint meeting a first criterion.

(CRM9) At least one non-transitory computer-readable medium may be encoded with instructions which, when executed by at least one processor of a system, cause the system to receive, at a first application programming interface (API) endpoint of a first computing system positioned before an egress point of a private network in which an application is executing, API calls from the application; to send, by the first computing system, the API calls over the internet to a second API endpoint; and to cause at least one notification to be sent to at least a first individual based at least in part on a first operational characteristic of the first API endpoint meeting a first criterion.

(CRM10) At least one non-transitory computer-readable medium may be configured as described in paragraph (CRM9), and may be encoded with additional instructions which, when executed by the at least one processor, further cause the system to configure the first computing system with the first API endpoint to proxy the API calls to the second API endpoint.

(CRM11) At least one non-transitory computer-readable medium may be configured as described in paragraph (CRM10), and may be encoded with additional instructions which, when executed by the at least one processor, further cause the system to configure the first computing system at least in part by receiving, by a second computing system, data defining at least the second API endpoint, the first operational characteristic, the first criterion, and an indicator of a destination for notifications to the first individual; generating, by the second computing system and using the data, a proxy configuration for the second API endpoint, the proxy configuration including the first API endpoint; deploying, by the second computing system, the proxy configuration on the first computing system; and sending, from the second computing system to a remote computing device, an indicator of the first API endpoint for use by the application.

(CRM12) At least one non-transitory computer-readable medium may be configured as described in any of paragraphs (CRM9) through (CRM11), wherein the first operational characteristic may comprise a quantity of the API calls sent to the second API endpoint, and the at least one computer-readable medium may be encoded with additional instructions which, when executed by the at least one processor, further cause the system to determine the quantity of the API calls sent to the second API endpoint.

(CRM13) At least one non-transitory computer-readable medium may be configured as described in paragraph (CRM12), and may be encoded with additional instructions which, when executed by the at least one processor, further cause the system to determine, based at least in part on the quantity of API calls sent to the second API endpoint, that a rate at which API calls are being made to the second API endpoint has exceeded a threshold.

(CRM14) At least one non-transitory computer-readable medium may be encoded with instructions which, when executed by at least one processor of a system, cause the system to receive, at a first application programming interface (API) endpoint of a first computing system positioned before an egress point of a private network in which an application is executing, an API call from the application; to send, by the first computing system, the API call over the internet to a second API endpoint; to receive, by the first computing system and from the second API endpoint, a response to the API call; and to initiate at least a first action based at least in part on a response to the API call being indicative of a deficiency in execution of the API call by the second API endpoint.

(CRM15) At least one non-transitory computer-readable medium may be configured as described in paragraph (CRM14), and may be encoded with additional instructions which, when executed by the at least one processor, further cause the system to configure the first computing system with the first API endpoint to proxy API calls to the second API endpoint.

(CRM16) At least one non-transitory computer-readable medium may be configured as described in paragraph (CRM14) or paragraph (CRM15), and may be encoded with additional instructions which, when executed by the at least one processor, further cause the system to receive, by a second computing system, data defining at least the second API endpoint, at least one criterion for determining that the response is indicative of the deficiency, and the first action; to generate, by the second computing system and using the data, a proxy configuration for the second API endpoint, the proxy configuration including the first API endpoint; to deploy, by the second computing system, the proxy configuration on the first computing system; and to send, from the second computing system to a remote computing device, an indicator of the first API endpoint for use by the application.

(CRM17) At least one non-transitory computer-readable medium may be configured as described in any of paragraphs (CRM14) through (CRM16), and may be encoded with additional instructions which, when executed by the at least one processor, further cause the system to determine to initiate the first action based at least in part on an error code of the response to the API call matching a first value.

(CRM18) At least one non-transitory computer-readable medium may be configured as described in paragraph (CRM17), and may be encoded with additional instructions which, when executed by the at least one processor, further cause the system to determine to initiate the first action based at least in part on a duration of time between sending a the API call to the second API endpoint and receipt of the response to the API call from the second API endpoint exceeding a threshold value.

(CRM19) At least one non-transitory computer-readable medium may be configured as described in any of paragraphs (CRM14) through (CRM18), and may be encoded with additional instructions which, when executed by the at least one processor, further cause the system to cause a notification of the deficiency to be sent to at least one individual.

(CRM20) At least one non-transitory computer-readable medium may be configured as described in any of paragraphs (CRM14) through (CRM19), and may be encoded with additional instructions which, when executed by the at least one processor, further cause the system to cause a trouble ticket to be opened with at least one support service.

(CRM21) At least one non-transitory computer-readable medium may be configured as described in any of paragraphs (CRM14) through (CRM20), and may be encoded with additional instructions which, when executed by the at least one processor, further cause the system to cause at least one notification to be sent to at least a first individual based at least in part on a first operational characteristic of the first API endpoint meeting a first criterion.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method, comprising:
receiving, at a first application programming interface (API) endpoint of a first computing system positioned before an egress point of a private network in which an application is executing, an API call from the application;
sending, by the first computing system, the API call over the internet to a second API endpoint; and
initiating at least a first action based at least in part on a response to the API call being indicative of a deficiency in execution of the API call by the second API endpoint.

2. The method of claim 1, further comprising:
configuring the first computing system with the first API endpoint to proxy API calls to the second API endpoint.

3. The method of claim 2, wherein configuring the first computing system further comprises:
receiving, by a second computing system, data defining at least the second API endpoint, at least one criterion for determining that the response is indicative of the deficiency, and the first action;
generating, by the second computing system and using the data, a proxy configuration for the second API endpoint, the proxy configuration including the first API endpoint;
deploying, by the second computing system, the proxy configuration on the first computing system; and
sending, from the second computing system to a remote computing device, an indicator of the first API endpoint for use by the application.

4. The method of claim 1, further comprising:
determining to initiate the first action based at least in part on an error code of the response to the API call matching a first value.

5. The method of claim 1, further comprising:
determining to initiate the first action based at least in part on a duration of time between sending a the API call to the second API endpoint and receipt of the response to the API call from the second API endpoint exceeding a threshold value.

6. The method of claim 1, wherein initiating the first action comprises:
causing a notification of the deficiency to be sent to at least one individual.

7. The method of claim 1, wherein initiating the first action comprises:
causing a trouble ticket to be opened with at least one support service.

8. A method, comprising:
receiving, at a first application programming interface (API) endpoint of a first computing system positioned before an egress point of a private network in which an application is executing , API calls from the application;
sending, by the first computing system, the API calls over the internet to a second API endpoint; and
causing at least one notification to be sent to at least a first individual based at least in part on a first operational characteristic of the first API endpoint meeting a first criterion.

9. The method of claim 8, further comprising:
configuring the first computing system with the first API endpoint to proxy the API calls to the second API endpoint.

10. The method of claim 9, wherein configuring the first computing system further comprises:
receiving, by a second computing system, data defining at least the second API endpoint, the first operational characteristic, the first criterion, and an indicator of a destination for notifications to the first individual;
generating, by the second computing system and using the data, a proxy configuration for the second API endpoint, the proxy configuration including the first API endpoint;
deploying, by the second computing system, the proxy configuration on the first computing system; and
sending, from the second computing system to a remote computing device, an indicator of the first API endpoint for use by the application.

11. The method of claim 9, further comprising:
determining a quantity of the API calls sent to the second API endpoint;
wherein the first operational characteristic comprises the quantity of the API calls sent to the second API endpoint.

12. The method of claim 11, further comprising:
determining, based at least in part on the quantity of API calls sent to the second API endpoint, that a rate at which API calls are being made to the second API endpoint has exceeded a threshold.

13. A system, comprising:
at least one processor; and
at least one computer-readable medium encoded with instructions which, when executed by the at least one processor, cause the system to:
receive, at a first application programming interface (API) endpoint of a first computing system positioned before an egress point of a private network in which an application is executing, an API call from the application,
send, by the first computing system, the API call over the internet to a second API endpoint,
receive, by the first computing system and from the second API endpoint, a response to the API call, and
initiate at least a first action based at least in part on a response to the API call being indicative of a deficiency in execution of the API call by the second API endpoint.

14. The system of claim 13, wherein the at least one computer-readable medium is further encoded with additional instructions which, when executed by the at least one processor, further cause the system to:
configure the first computing system with the first API endpoint to proxy API calls to the second API endpoint.

15. The system of claim 13, wherein the at least one computer-readable medium is further encoded with additional instructions which, when executed by the at least one processor, further cause the system to:
receive, by a second computing system, data defining at least the second API endpoint, at least one criterion for determining that the response is indicative of the deficiency, and the first action;
generate, by the second computing system and using the data, a proxy configuration for the second API endpoint, the proxy configuration including the first API endpoint;
deploy, by the second computing system, the proxy configuration on the first computing system; and
send, from the second computing system to a remote computing device, an indicator of the first API endpoint for use by the application.

16. The system of claim 13, wherein the at least one computer-readable medium is further encoded with additional instructions which, when executed by the at least one processor, further cause the system to:
determine to initiate the first action based at least in part on an error code of the response to the API call matching a first value.

17. The system of claim 13, the at least one computer-readable medium is further encoded with additional instructions which, when executed by the at least one processor, further cause the system to:
determine initiate the first action based at least in part on a duration of time between sending a the API call to the second API endpoint and receipt of the response to the API call from the second API endpoint exceeding a threshold value.

18. The system of claim 13, the at least one computer-readable medium is further encoded with additional instructions which, when executed by the at least one processor, further cause the system to:
cause a notification of the deficiency to be sent to at least one individual.

19. The system of claim 13, the at least one computer-readable medium is further encoded with additional instructions which, when executed by the at least one processor, further cause the system to:
cause a trouble ticket to be opened with at least one support service.

20. The system of claim 13, the at least one computer-readable medium is further encoded with additional instructions which, when executed by the at least one processor, further cause the system to:
cause at least one notification to be sent to at least a first individual based at least in part on a first operational characteristic of the first API endpoint meeting a first criterion.
